(19) United States
(12) Patent Application Publication
(10) Pub. No.: US 2024/0179768 A1
(43) Pub. Date: May 30, 2024

(54) METHOD AND SYSTEM FOR MANAGING WIRELESS COMMUNICATION AND NON-TRANSITORY COMPUTER READABLE STORAGE MEDIUM

(71) Applicant: HTC Corporation, Taoyuan City (TW)

(72) Inventors: Kai-Hsiu CHEN, Taoyuan City (TW); WeiChih KUO, Taoyuan City (TW); Jing Lung WU, Taoyuan City (TW)

(21) Appl. No.: 18/058,764

(22) Filed: Nov. 24, 2022

(51) Int. Cl. H04W 76/14; H04W 64/00

(52) U.S. Cl. CPC H04W 76/14; H04W 64/006; H04W 84/18

(57) ABSTRACT

A method for managing wireless communication including the following operations: establishing a wireless connection between a host device and a slave device, wherein the slave device transmit motion data to the host device by a connection interval through the wireless connection; and responsive to determining, by the host device, that the slave device has a decrement of movement according to the motion data, increasing the connection interval of the slave device.

### BACKGROUND

### Technical Field

The present disclosure relates to wireless communication. More particularly, the present disclosure relates to a method and a system for managing wireless communication and a non-transitory computer readable storage medium.

### Description of Related Art

To capture the motion of the human body or the accessory in accuracy, the virtual reality (VR) system includes a number of motion detectors that communicate with the head-mounted device (HMD) via Bluetooth Low Energy (BLE) connections. The motion detectors collect and transmit pose data thereof to the HMD. However, the total BLE bandwidth of the HMD is limited, and therefore the packets of the motion detectors may collision, increasing the packet drop rate.

### SUMMARY

The disclosure provides a method for managing wireless communication. The method includes the following operations: establishing a wireless connection between a host device and a slave device, wherein the slave device transmit motion data to the host device by a connection interval through the wireless connection; and responsive to determining, by the host device, that the slave device has a decrement of movement according to the motion data, increasing the connection interval of the slave device.

The disclosure provides a wireless communication system including a slave device and a host device. The host device is configured to establish a wireless connection to the slave device, and configured to: receive motion data from the slave device by a connection interval through the wireless connection; and configure the connection interval to be positively correlated to the motion magnitude of the slave device.

The disclosure provides a non-transitory computer readable storage medium storing a plurality of computer readable instructions for controlling a host device. The plurality of computer readable instructions, when being executed by the host device, cause the host device to perform: establishing a wireless connection between the host device and a slave device, wherein the slave device transmit motion data to the host device by a connection interval through the wireless connection; and responsive to determining that the slave device has a decrement of movement according to the motion data, increasing the connection interval of the slave device.

It is to be understood that both the foregoing general description and the following detailed description are by examples, and are intended to provide further explanation of the disclosure as claimed.

### BRIEF DESCRIPTION OF THE DRAWINGS

FIG. 1 is a simplified functional block diagram of a wireless communication system according to one embodiment of the present disclosure.

FIG. 2 is a flowchart of a method for managing wireless communication according to one embodiment of the present disclosure.

FIG. 3 is a schematic diagram showing the establishment of connection between the host device and the slave device.

FIG. 4 is a schematic diagram showing the data transmission between the host device and the slave devices.

FIG. 5 is a schematic diagram showing the data transmission between the host device and the slave devices after operation S210 is performed.

FIG. 6 is a schematic diagram showing the data transmission between the host device and the slave devices after operation S216 is performed.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

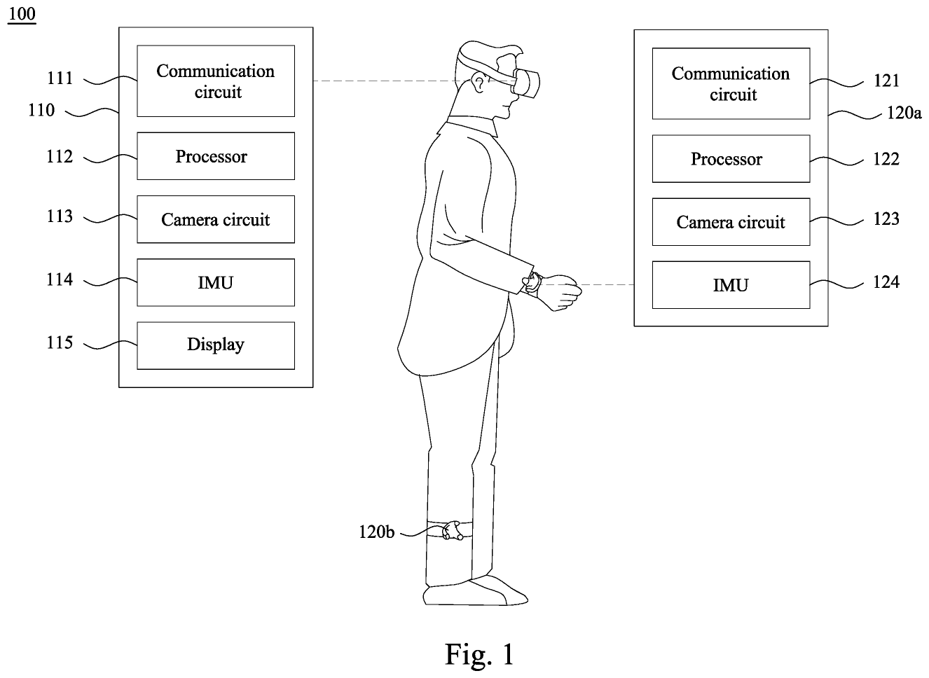

FIG. 1 is a simplified functional block diagram of a wireless communication system 100 according to one embodiment of the present disclosure. The wireless communication system 100 comprises a host device 110 and a plurality of slave devices 120a-120b.

The host device 110 comprises a communication circuit 111, a processor 112, a camera circuit 113, an inertial measurement unit (IMU) 114 and a display 115. The communication circuit 111 can establish wireless connections with the slave devices 120a-120b to transmit and receive data to and from the slave devices 120a-120b. The aforesaid wireless connections may be Bluetooth Low Energy (BLE) connections, Wi-Fi connections, other suitable wireless connections or any combination thereof. The camera circuit 113 includes a visible-light camera for capturing images of the physical environment. The processor 112 matches the captured images with a built-in map regarding the physical environment, in order to locate the position of the host device 110 in the physical environment through, for example, SLAM technique. The IMU 114 includes accelerometers, gyroscopes, magnetometers or any combination thereof, so as to measure the pose (e.g., the 6-dimension pose), the angular velocity, angular acceleration, velocity, acceleration or any combination thereof of the host device 110.

The slave devices 120a-120b are similar to each other, and therefore only the configuration of the slave device 120a is discussed. The slave device 120a comprises a communication circuit 121, a processor 122, a camera circuit 123 and an IMU 124. The communication circuits 121 of the slave device 120a can establish the wireless connection with the communication circuit 111 of the host device. The host device 110 may transmit, via the wireless connection, a built-in map to the slave device 120a, so that the slave device 120a may use the camera circuit 123 and the map to perform SLAM to locate the position of the slave device 120a in the physical environment. The IMU 124 of the slave device 120a is similar to the IMU 114 of the host device 110. The IMU 124 may measure the pose, the angular velocity, the angular acceleration, the velocity, the acceleration or any combination thereof of the slave device 120a (hereinafter referred to as “motion data”). The slave device 120a can transmits the motion data to the host device 110 through the wireless connection.

In some embodiments, the processor 112 and 122 each can be a microprocessor, a central processing unit (CPU), an application-specific integrated circuit (ASIC), a digital signal processor (DSP), a field programmable gate array (FPGA) or any combination thereof.

Accordingly, the host device 110 can establish wireless connections (e.g., the BLE connections, but this disclosure is not limited thereto) with the slave devices 120a-120b to receive their motion data. In some embodiments, the slave devices 120a-120b may be motion trackers mounted on an accessory device (e.g., a gun-shaped controller or a racket-shaped controller) or on the body member of the user, so that the host device 110 can track the movement of the accessory device or the user. In other embodiments, the slave devices 120a-120b may be mounted on static object (e.g., the wall of a room) to facilitate the host device 110 rendering the virtual environment. It will be understood that the number of the slave devices 120a-120b is not intended to limit the scope of the present disclosure but is instead provided as an exemplary embodiment.

In some embodiments, the host device 110 includes an optical see-through system and/or a video see-through system for providing augmented reality (AR) environment. An optical see-through system may allow actual direct viewing of a real-world environment (e.g., via transparent lenses) and may, at the same time, project images of a virtual object into the visual field of the user (e.g., by the display 115) thereby augmenting the real-world environment perceived by the user with the virtual object. A video see-through system captures images of the real-world environment (e.g., by the camera circuit 113) and provide these images to the user (e.g., by the display 115) to allow in-direct viewing of the real-world environment and may, at the same time, overlay images of the virtual objects onto the images of the real-world environment. In some embodiments, the virtual objects are allowed to interact with the real-world environment provided by the optical or video see-through system, so that the host device 110 may provide a mixed reality (MR) environment to the user. In other embodiments, the host device 110 is capable of providing totally immersive virtual reality (VR) environment to the user (e.g., by the display 115).

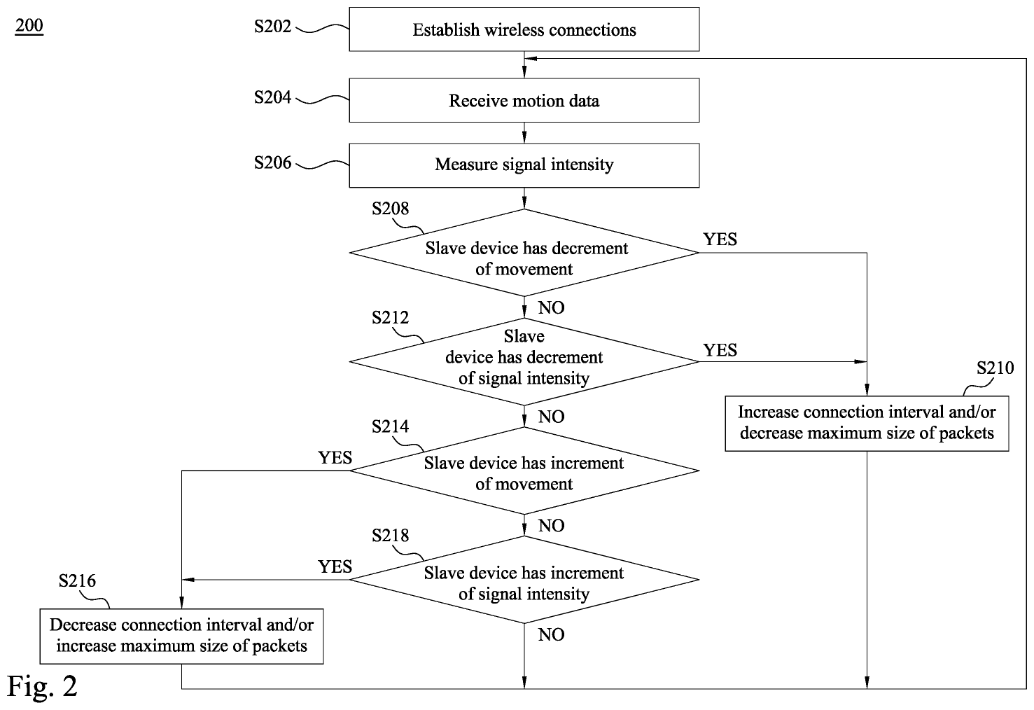

FIG. 2 is a flowchart of a method 200 for managing wireless communication according to one embodiment of the present disclosure. Any combination of the features of the method 200 may be embodied in instructions stored in a non-transitory computer readable medium. When the instructions are executed by the processor 112 and/or 122, the instructions may cause some or all of the method 200 to be performed.

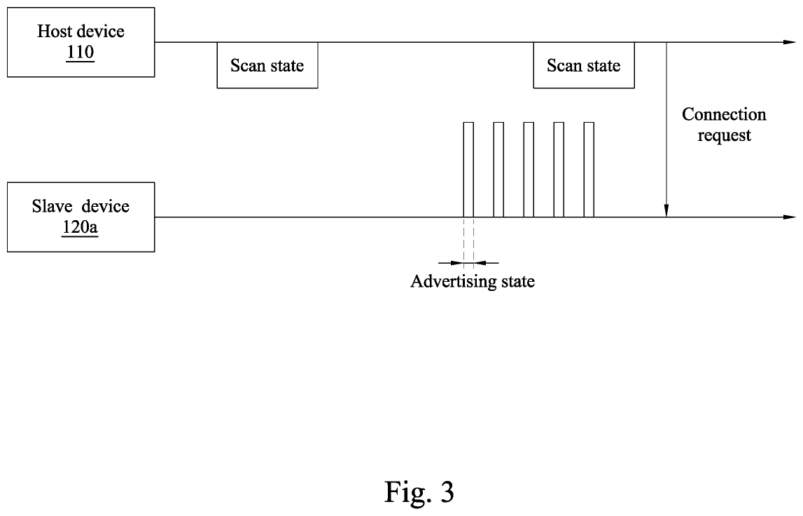

Reference is made to FIGS. 2-3, in which FIG. 3 is a schematic diagram showing the establishment of connection between the host device 110 and the slave device 120a. In operation S202, the host device 110 establishes wireless connections (e.g., BLE connections, but this disclosure is not limited thereto) with the slave devices 120a-120b. The host device 110 intermittently enters the scan state. The slave device 120a repeats the advertising state. The slave device 120a may switch the channel in each advertising state. When the scan state of the host device 110 and the advertising state of the slave device coincide with each other, the host device 110 receives the advertising packet of the slave device 120a. In response, the host device 110 sends a connection request to the slave device 120a to establish the wireless connection. The host device 110 may establish the wireless connections to the other slave device 120b in a similar manner, and therefore the detailed descriptions thereof are omitted.

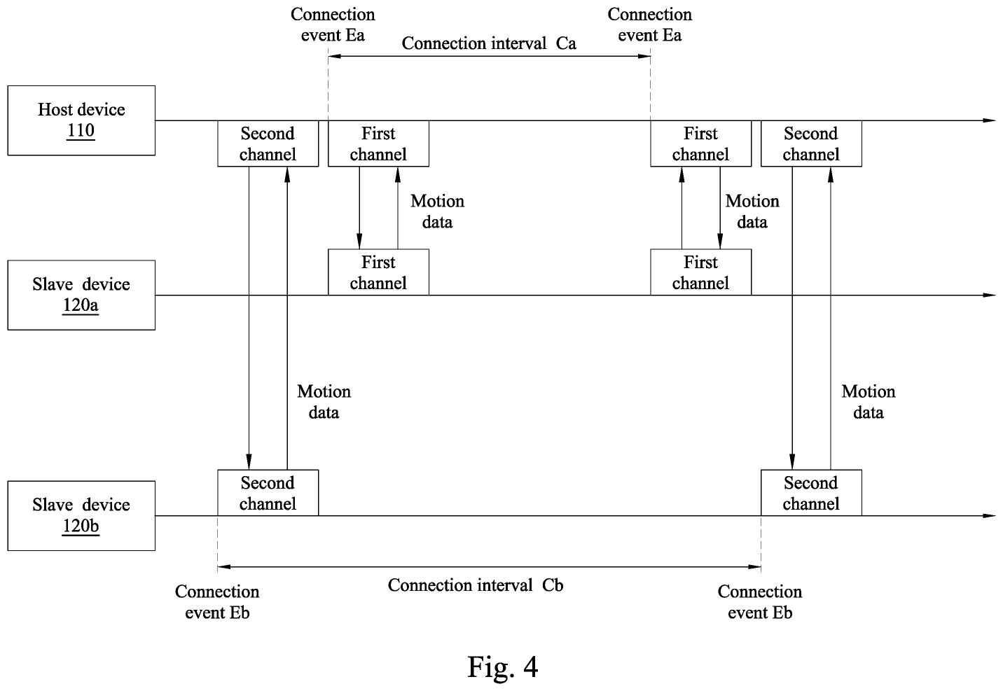

In operation S204, the host device 110 receives the motion data from the slave devices 120a-120b. Reference is made to FIG. 4, in which FIG. 4 is a schematic diagram showing the data transmission between the host device 110 and the slave devices 120a-120b. The slave devices 120a-120b transmit respective motion data to the host device 110 by respective connection intervals.

For example, the host device 110 and the slave device 120a start to communicate with each other at a periodically conducted “connection event Ea,” through a first channel. The time interval between the connection events Ea of the slave device 120a is a “connection interval Ca.” At the connection event Ea of the slave device 120a, the host device 110 and the slave device 120a start to transmit and receive data to and from each other. Therefore, the slave device 120a transmits the motion data to the host device 110 by the period of the connection interval Ca. Similarly, the host device 110 and the slave device 120b communicate with each other through a second channel, and the time interval between the connection events Eb of the slave device 120b is a “connection interval Cb.” The slave device 120b transmits the motion data to the host device 110 by the period of connection interval Cb.

In some embodiments, the host device 110 may configure the connection intervals Ca and Cb based on the body members that the slave devices 120a-120b are mounted to. The host device 110 may compare the identifications (IDs) or MAC addresses of the slave devices 120a-120b with information of a check list to identify the type of each slave devices 120a-120b, so as to determine the body member that the slave devices 120a-120b mounted to. The host device 110 may also determine the body member that the slave devices 120a-120b mounted to base on the user configuration to the host device 110, or by any suitable manners. As shown in FIG. 4, for example, the host device 110 configures the connection interval Ca of the slave device 120a mounted on the hand to be shorter than the connection interval Cb of the slave device 120b mounted on the leg, since the hand moves more frequently and/or with larger range than the leg in most of the applications, but this disclosure is not limited thereto. In some embodiments, the connection interval Ca may be longer than or equal to the connection interval Cb, as appropriate.

In operation S206, the host device 110 measures the signal intensity of each of the slave devices 120a-120b. For example, the host device 110 can measure the received signal strength indications (RSSIs) of the slave devices 120a-120b.

In operation S208, the host device 110 determines that whether one or more of the slave devices 120a-120b have decrements of movement, according to the motion data. The “decrement of movement” may be the decrement of velocity, acceleration, variation of pose, angular acceleration, angular velocity or any combination thereof of one of the slave device.

In some embodiments, for example, the host device 110 monitors one or more of the velocity, the acceleration, the variation of pose, the angular acceleration, the angular velocity of the slave device 120a, according to the motion data. The host device 110 also stores various types of thresholds of the slave device 120a for comparing with the velocity, the acceleration, the variation of pose, the angular acceleration, the angular velocity of the slave device 120a, respectively. When the host device 110 determines that one of the velocity, the acceleration, the variation of pose, the angular acceleration and the angular velocity of the slave device 120a decreases from higher than to lower than the corresponding type of threshold, the host device 110 determines that the slave device 120a has the decrement of movement. The host device 110 may determines the decrement of movement of the slave device 120b in a similar manner, and therefore the detailed descriptions thereof are omitted.

When the determination of operation S208 is “YES” (i.e., one or more of the slave devices 120a-120b have the decrements of movement), the host device 110 conducts operation S210 to the one or more of the slave devices 120a-120b that have the decrements of movement, while the host device 110 conducts one or more of operations S212-S218 to the other of the slave devices 120a-120b that does not have the decrement of movement.

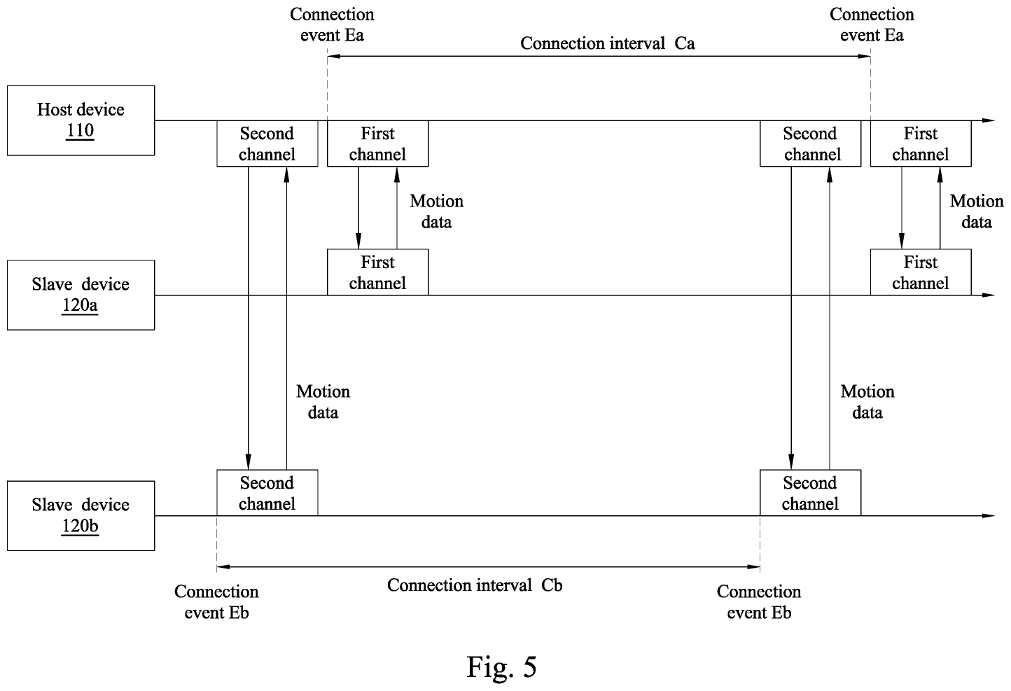

Reference is made to FIGS. 4-5, in which FIG. 5 is a schematic diagram showing the data transmission between the host device 110 and the slave devices 120a-120b after operation S210 is performed. In the embodiment of FIG. 5, the slave device 120a is determined to have the decrement of movement, while the slave device 120b is not. Therefore, the host device 110 performs operation S210 to the slave device 120a to increase the connection interval Ca by, for example, renegotiating a longer connection interval Ca with the slave device 120a. As shown in FIG. 5, for example, the connection interval Ca is extended from shorter than to approximately equal to the connection interval Cb. In some embodiments, the connection interval Ca may be increased to smaller than or equal to 4 seconds. After operation S210 is finished, the host device 110 may repeat operation S204 to the slave device 120a.

In some embodiments, the host device 110 maintains the connection interval Ca, but reduces the maximum size of packets transmitted between the host device 110 and the slave device 120a by, for example, renegotiating a smaller maximum transmission unit (MTU) with the slave device 120a. In other embodiments, the host device 110 increases the connection interval Ca and also reduces the maximum size of packets transmitted between the host device 110 and the slave device 120a. Since the slave device 120a has the decrement of movement, the host device 110 needs not to track the slave device 120a in high precision. Decreasing the maximum size of packets reduces the time that the slave device 120a transmits a packet, so as to provide more time slots for other slave devices (e.g., the slave device 120b) to transmit their motion data.

As mentioned above, the host device 110 may conduct one or more of operations S212-S218 to the slave device 120b. In operation S212, the host device 110 determines that whether the slave device 120b has a decrement of signal intensity. In specific, when the signal intensity of the slave device 120b decreases from higher than to lower than a signal threshold stored in the host device 110, the host device 110 determines that the slave device 120b has the decrement of signal intensity. For example, the signal intensity of the slave device 120b may decrease in the circumstance that the antenna of the host device 110 is a directive antenna that mainly radiates towards the front of the user and the user moves his/her leg mounted with the slave device 120b backward. When the determination of operation S212 is “YES,” the host device 110 conducts operation S210 to the slave device 120b to increase the connection interval Cb.

When the determination of operation S212 is “No,” the host device 110 conducts operation S214 to determine whether the slave devices 120b has an increment of movement, according to the motion data. The “increment of movement” may be the increment of velocity, acceleration, pose, angular acceleration, angular velocity or any combination thereof of one of the slave device.

In some embodiments, for example, the host device 110 monitors one or more of the velocity, the acceleration, the pose, the angular acceleration, the angular velocity of the slave device 120b, according to the motion data. The host device 110 also stores various types of thresholds of the slave device 120b for comparing with the velocity, the acceleration, the variation of pose, the angular acceleration, the angular velocity of the slave device 120b, respectively. When the host device 110 determines that one of the velocity, the acceleration, the variation of pose, the angular acceleration and the angular velocity of the slave device 120b increases to reach the corresponding type of threshold, the host device 110 determines that the slave device 120b has the increment of movement.

In some embodiments, the thresholds of the slave device 120a and the thresholds of the slave device 120b may be different. For example, the slave device 120a mounted on the hand may have lower thresholds than the slave device 120b mounted on the leg.

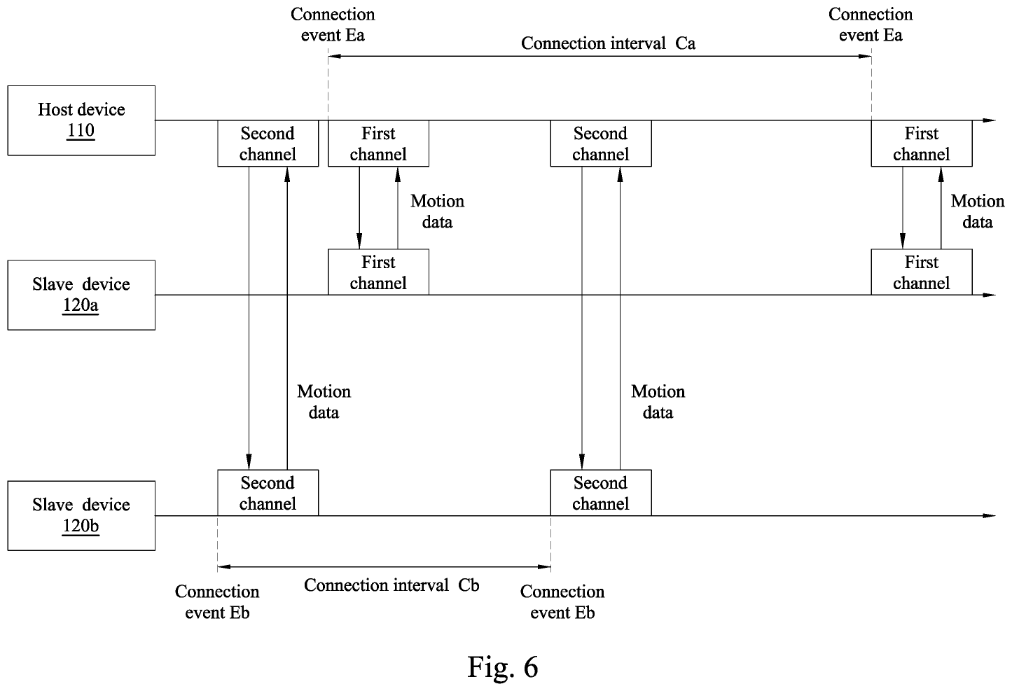

Reference is made to FIGS. 5-6, in which FIG. 6 is a schematic diagram showing the data transmission between the host device 110 and the slave devices 120a-120b after operation S216 is performed. When the determination of operation S214 is “YES,” the host device 110 conducts operation S216 to decrease the connection interval Cb by, for example, renegotiating a shorter connection interval Cb with the slave device 120b. As shown in FIG. 6, for example, the connection interval Cb is reduced from approximately same as to shorter than the connection interval Ca. In some embodiments, the connection interval Ca may be decreased to larger than or equal to 7.5 milliseconds (ms). After operation S216 is finished, the host device 110 may repeat operation S204 to the slave device 120b.

In some embodiments, the host device 110 maintains the connection interval Cb, but increases the maximum size of packets transmitted between the host device 110 and the slave device 120b by, for example, renegotiating a larger maximum transmission unit with the slave device 120b. In other embodiments, the host device 110 decreases the connection interval Cb and also increases the maximum size of packets transmitted between the host device 110 and the slave device 120b. The increment of the maximum size of packets allows the slave device 120b having the increment of movement to transmit more motion data in each packet, thereby facilitating the host device 110 to track the slave device 120b in high precision.

When the determination of operation S214 is “No,” the host device 110 conducts operation S218 to determine whether the slave devices 120b has a increment of signal intensity. In specific, when the signal intensity of the slave device 120b increases to reach the signal threshold, the host device 110 determines that the device 120b has the increment of signal intensity. For example, the signal intensity of the slave device 120b may increase in the circumstance that the antenna of the host device 110 is the directive antenna that mainly radiates towards the front of the user and the user moves his/her leg mounted with the slave device 120b forward.

When the determination of operation S218 is “YES,” the host device 110 conducts operation S216 to the slave device 120b. On the other hand, if the determination of operation S218 is “No,” the host device 110 repeats operation S204 to slave device 120b.

According to operations S208, S210, S214 and S216, the host device 110 configures the connection intervals and/or the maximum sizes of the packets of the slave devices 120a-120b to be positively correlated to the motion magnitude of the slave device. The “motion magnitude” may be the magnitude of the velocity, the magnitude of the acceleration, the magnitude of the variation of pose, the magnitude of the angular acceleration, the magnitude of the angular velocity or any combination thereof of the slave device.

According to operations S212, S210, S216 and S218, the host device 110 configures the connection intervals and/or the maximum sizes of the packets of the slave devices 120a-120b to be positively correlated to the signal intensity of the slave device.

It will be understood that the method 200 may include greater or fewer operations than illustrated in the flowchart and the operations may be performed in any order, as appropriate. For example, operations S204 and S206 may be conducted simultaneously or be swapped with each other. As another example, operations S208-S212 may be conducted simultaneously with or be swapped with operations S214-S218.

As can be appreciated from the above, the packet transmission frequency (i.e., the reciprocal of the connection interval) and/or the maximum packet size of the slave device with less movement are reduced, in order to provide more time slots for the communication of the slave device with frequent movement. On the other hand, the packet transmission frequency and/or the maximum packet size of the slave device with frequent movement are increased, thereby facilitating the host device to track such slave device.

Further, the packet transmission frequency and/or the maximum packet size of the slave device with poor signal intensity is reduced to decrease the times of packet re-transmission due to failure of the packet transmission, thereby providing more time slots for the wireless communication.

Certain terms are used in the specification and the claims to refer to specific components. However, those of ordinary skill in the art would understand that the same components may be referred to by different terms. The specification and claims do not use the differences in terms as a way to distinguish components, but the differences in functions of the components are used as a basis for distinguishing. Furthermore, it should be understood that the term “comprising” used in the specification and claims is open-ended, that is, including but not limited to. In addition, “coupling” herein includes any direct and indirect connection means. Therefore, if it is described that the first component is coupled to the second component, it means that the first component can be directly connected to the second component through electrical connection or signal connections including wireless transmission, optical transmission, and the like, or the first component is indirectly electrically or signally connected to the second component through other component(s) or connection means.

It will be understood that, in the description herein and throughout the claims that follow, the phrase “and/or” includes any and all combinations of one or more of the associated listed items. Unless the context clearly dictates otherwise, the singular terms used herein include plural referents.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the present disclosure.

In view of the foregoing, it is intended that the present disclosure cover modifications and variations of this disclosure provided they fall within the scope of the following claims and their equivalents.

What is claimed is:

1. A method for managing wireless communication, comprising:
establishing a wireless connection between a host device and a slave device, wherein the slave device transmit motion data to the host device by a connection interval through the wireless connection; and
responsive to determining, by the host device, that the slave device has a decrement of movement according to the motion data, increasing the connection interval of the slave device.

2. The method of claim 1, further comprising:
responsive to determining, by the host device, that the slave device has a decrement of signal intensity, increasing the connection interval of the slave device.

3. The method of claim 2, wherein responsive to determining that the slave device has the decrement of movement or the decrement of signal intensity, a maximum size of packets transmitted between the slave device and the host device is reduced.

4. The method of claim 1, wherein determining that the slave device has the decrement of movement comprising:
obtaining velocity, acceleration, pose, angular acceleration, angular velocity or any combination thereof of the slave device from the motion data; and
responsive to determining, by the host device, that one of the velocity, the acceleration, variation of the pose, the angular acceleration and the angular velocity of the slave device decreases from higher than to lower than a corresponding type of threshold, determining that the slave device has the decrement of movement.

5. The method of claim 1, further comprising:
responsive to determining, by the host device, that the slave device has an increment of movement according to the motion data, decreasing the connection interval of the slave device.

6. The method of claim 5, further comprising:
responsive to determining, by the host device, that the slave device has an increment of signal intensity, decreasing the connection interval of the slave device.

7. The method of claim 6, wherein responsive to determining that the slave device has the increment of movement or the increment of signal intensity, a maximum size of packets transmitted between the slave device and the host device is increased.

8. The method of claim 1, further comprising:
determining, by the host device, a body member that the slave device is mounted to; and
configuring the connection interval of the slave device, according to the body member that the slave device is mounted to.

9. A wireless communication system, comprising:
a slave device;
a host device, configured to establish a wireless connection to the slave device, and configured to:
receive motion data from the slave device by a connection interval through the wireless connection; and
configure the connection interval to be positively correlated to a motion magnitude of the slave device.

10. The wireless communication system of claim 9, wherein the host device is further configured to configure a maximum size of packets transmitted between the slave device and the host device to be positively correlated to the motion magnitude of the slave device.

11. The wireless communication system of claim 9, wherein the host device is further configured to configure the connection interval to be positively correlated to signal intensity of the slave device.

12. The wireless communication system of claim 11, wherein the host device is further configured to configure a maximum size of packets transmitted between the slave device and the host device to be positively correlated to the signal intensity of the slave device.

13. The wireless communication system of claim 9, wherein the host device configures the connection interval to be positively correlated to the motion magnitude of the slave device by:
obtaining velocity, acceleration, pose, angular acceleration, angular velocity or any combination thereof of the slave device from the motion data; and
responsive to one of the velocity, the acceleration, variation of the pose, the angular acceleration and the angular velocity of the slave device decreases from higher than to lower than a corresponding type of threshold, decreasing the connection interval.

14. The wireless communication system of claim 9, wherein the host device is further configured to:
determine a body member that the slave device is mounted to; and
configure the connection interval, according to the body member that the slave device is mounted to.

15. A non-transitory computer readable storage medium, storing a plurality of computer readable instructions for controlling a host device, wherein the plurality of computer readable instructions, when being executed by the host device, cause the host device to perform:
establishing a wireless connection between the host device and a slave device, wherein the slave device transmit motion data to the host device by a connection interval through the wireless connection; and
responsive to determining that the slave device has a decrement of movement according to the motion data, increasing the connection interval of the slave device.

16. The non-transitory computer readable storage medium of claim 15, wherein the host device further performs:
responsive to determining that the slave device has a decrement of signal intensity, increasing the connection interval of the slave device.

17. The non-transitory computer readable storage medium of claim 16, wherein responsive to determining that the slave device has the decrement of movement or the decrement of signal intensity, a maximum size of packets transmitted between the slave device and the host device is reduced.

18. The non-transitory computer readable storage medium of claim 15, wherein the host device further performs:
responsive to determining that the slave device has an increment of movement according to the motion data, decreasing the connection interval of the slave device.

19. The non-transitory computer readable storage medium of claim 18, wherein the host device further performs:
responsive to determining that the slave device has an increment of signal intensity, decreasing the connection interval of the slave device.

20. The non-transitory computer readable storage medium of claim 19, wherein responsive to determining that the slave device has the increment of movement or the increment of signal intensity, a maximum size of packets transmitted between the slave device and the host device is increased.
